(19) United States
(12) Patent Application Publication
(10) Pub. No.: US 2014/0153757 A1
(43) Pub. Date: Jun. 5, 2014

(54) METHOD OF PROCESSING SOUND AND HEARING APPARATUS USING THE SAME

(71) Applicant: Samsung Electronics Co., Ltd., Suwon-si (KR)

(72) Inventors: Yun Seo KU, Seoul (KR); Jun Il SOHN, Yongin-si (KR); Jun Whon UHM, Anyang-si (KR); Heun Chul LEE, Pocheon-si (KR); Dong Wook KIM, Seoul (KR); Jong Jin KIM, Hwaseong-si (KR); Jong Min CHOI, Seoul (KR)

(73) Assignee: SAMSUNG ELECTRONICS CO., LTD., Suwon-si (KR)

(21) Appl. No.: 14/092,833

(22) Filed: Nov. 27, 2013

(30) Foreign Application Priority Data
Nov. 28, 2012 (KR) 10-2012-0136106

(51) Int. Cl. H04R 25/00

(52) U.S. Cl. CPC H04R 25/00
USPC 381/317

(57) ABSTRACT

A hearing apparatus and a method thereof for processing a noise included in an input signal are provided. The method of processing noise involves: pairing a hearing apparatus with an electronic appliance; extracting noise characteristic information of the paired electronic appliance; and processing noise from the electronic appliance included in an input signal based on the noise characteristic information.

### CROSS-REFERENCE TO RELATED APPLICATION(S)

This application claims the benefit under 35 USC §119(a) of Korean Patent Application No. 10-2012-0136106 filed on Nov. 28, 2012, in the Korean Intellectual Property Office, the entire disclosure of which is incorporated herein by reference for all purposes.

### BACKGROUND

1. Field

The following description relates to a hearing apparatus that processes noise from electronic appliances and a method of processing noise, and to a hearing apparatus that processes and removes noise generated by home appliances located in vicinity of the hearing apparatus and a method of removing such noise.

2. Description of Related Art

A hearing apparatus processes an input signal and outputs the processed signal to assist a user wearing the hearing apparatus hears better. In an environment in which electronic appliances such as a cleaner, a washing machine, a microwave oven, range hood, and the like generate noise, the hearing apparatus picks up the noise from the appliances with other sound, causing the user to hear an amplified version of the noise.

A hearing apparatus may be configured to estimate and remove background noise using a digital signal processor (DSP) equipped inside the hearing apparatus. However, in a hearing apparatus that uses a noise estimation algorithm, the complex algorithm used in the hearing apparatus may increase the amount of calculation and the processing time required for the hearing apparatus to estimate ambient noise. The additional processing to remove the background noise may cause a delay in delivering the processed input signal to the user.

Further, hearing apparatus are generally manufactured in small size and uses batteries that are limited in size and capacity. The processing involved in handling background noise may increase power consumption of the hearing apparatus, causing inconvenience to users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect, there is provided a method of processing noise, the method involving: pairing a hearing apparatus with an electronic appliance; extracting noise characteristic information of the paired electronic appliance; and processing noise from the electronic appliance included in an input signal based on the noise characteristic information.

The pairing with the pre-registered electronic appliance may be performed while the pre-registered electronic appliance is in operation; and the extracting may be performed using identification (ID) information of the paired electronic appliance.

The pre-registered electronic device may be a home appliance.

The noise characteristic information may include time characteristic information; and the processing of the noise may involve reducing or eliminating the noise from the electronic appliance that is included in the input signal using the time characteristic information.

The noise characteristic information may include frequency characteristic information, and the processing of the noise may involve processing the noise from the electronic appliance that is included in the input signal using the frequency characteristic information.

The processing of the noise may involve parallel processing noise from a plurality of electronic appliances based on the noise characteristic information of each of the plurality of electronic appliances that are paired.

The processing of the noise may involve processing noise from a plurality of electronic appliances based on priority of the plurality of electronic appliances.

The processing of the noise may involve processing noise from a plurality of electronic appliances based on noise levels of the plurality of electronic appliances that are paired, distances between the hearing apparatus and each of the plurality of electronic appliances that are paired, or a combination thereof.

The processing of the noise may involve outputting the input signal including the noise from the electronic appliance when the input signal includes a user-intended signal from the paired electronic appliance.

In another general aspect, there is provided a method of processing noise involving: pairing with an electronic appliance; obtaining noise characteristic information of the electronic appliance during the pairing; and processing noise from the electronic appliance that is included in an input signal, based on the noise characteristic information.

The pairing may involve pairing with the electronic appliance in response to a determination that that the electronic appliance is in operation.

The electronic appliance may be a home appliance.

The processing of the noise may involve processing the noise from the electronic appliance using time characteristic information of the electronic appliance included in the noise characteristic information.

The processing of the noise may involve processing the noise from the electronic appliance using frequency characteristic information of the electronic appliance included in the noise characteristic information.

The processing of the noise may involve parallel processing noise from a plurality of electronic appliances based on the noise characteristic information of the plurality of electronic appliances that are paired.

The processing of the noise may involve processing noise from a plurality of electronic appliances based on priority of the plurality of electronic appliances that are paired.

The processing of the noise may involve processing noise from a plurality of electronic appliances based on noise levels of the plurality of electronic appliances that are paired, distances between the hearing apparatus and each of the plurality of electronic appliances that are paired, or a combination thereof.

The processing of the noise may involve outputting the input signal that includes the noise from the electronic appliance in response to a determination that the input signal includes a user-intended signal from the electronic appliance.

In another general aspect, there is provided a hearing apparatus including: a pairing unit configured to pair with a pre-registered electronic appliance; and a noise processing unit configured to extract noise characteristic information of the paired electronic appliance and to process noise from the electronic appliance that is included in an input signal based on the noise characteristic information.

The pairing unit may be configured to pair with the pre-registered electronic appliance in response to a determination that the pre-registered electronic appliance is in operation; and the noise processing unit may be configured to extract the noise characteristic information using identification (ID) information of the paired electronic appliance.

The pre-registered electronic appliance may be a home appliance.

The noise processing unit may be configured to process the noise from the electronic appliance included in the input signal using time characteristic information of the electronic appliance included in the noise characteristic information.

The noise processing unit may be configured to process the noise from the electronic appliance included in the input signal using frequency characteristic information of the electronic appliance included in the noise characteristic information.

In another general aspect, there is provided a hearing apparatus including: a pairing unit configured to pair with an electronic appliance that is in operation; an information receiving unit configured to receive noise characteristic information of the electronic appliance from the paired electronic appliance; and a noise processing unit configured to process noise from the electronic appliance that is included in an input signal, based on the noise characteristic information.

The pairing unit may be configured to pair with an electronic appliance that is in operation within a predetermined distance from the hearing apparatus; and the electronic appliance may include a home appliance.

The noise characteristic information may include characteristic information of the electronic appliance, frequency characteristic information of the electronic appliance, or a combination thereof.

In another general aspect, there is provided a non-transitory computer readable recording medium storing a program to cause a processing device to perform the methods described above.

Other features and aspects will be apparent from the following detailed description, the drawings, and the claims.

### BRIEF DESCRIPTION OF THE DRAWINGS

FIG. 1 is a diagram illustrating a pairing operation between an example of a hearing apparatus and electronic appliances.

FIG. 2 is a flowchart illustrating an example of a method of processing noise.

FIG. 3 is a flowchart illustrating another example of a method of processing noise.

FIG. 4 is a flowchart illustrating another example of a method of processing noise.

FIG. 5 is a diagram illustrating an example of a hearing apparatus.

FIG. 6 is a diagram illustrating an example of a method of extracting noise characteristic information of an electronic appliance.

FIG. 7 is a diagram illustrating another example of a method of processing noise.

FIG. 8 is a flowchart illustrating another example of a method of processing noise.

FIG. 9 is a diagram illustrating another example of a hearing apparatus.

FIG. 10 is a diagram illustrating another example of a method of processing noise.

FIG. 11 is a diagram illustrating another example of a hearing apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

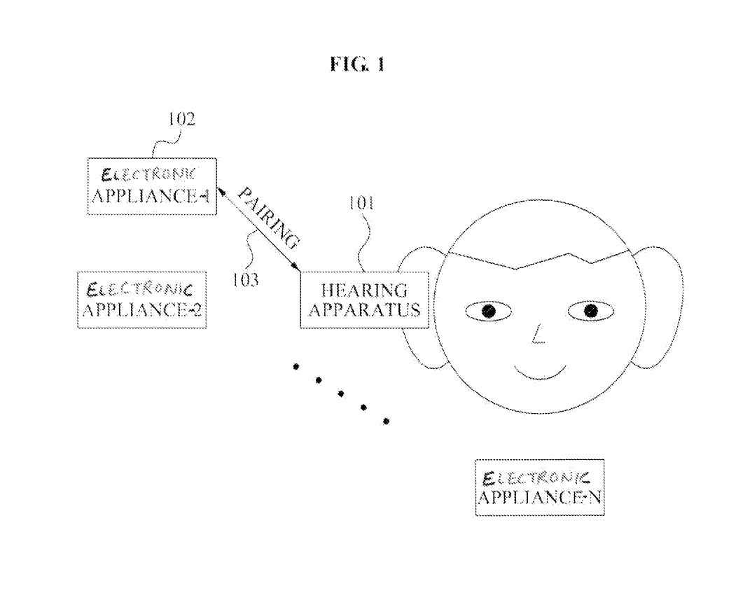

FIG. 1 illustrates an example of a pairing operation of a hearing apparatus 101.

The hearing apparatus 101 may be a hearing aid that helps a person with hearing impairment to hear better. Referring to FIG. 1, while a user is wearing the hearing apparatus 101, the hearing apparatus 101 may receive a variety of sound from its surrounding, including but not limited to the voice signals of people around the user, noise signals generated by operation of electronic appliances disposed in the vicinity of the user, and other sound signals generated by objects such as furniture, kitchen tools, and the like. The electronic appliances may be home appliances such as a cleaner, a washing machine, a microwave oven, range hood and the like.

The hearing apparatus 101 may register the electronic appliances disposed within a predetermined radius of the hearing apparatus 101.

For example, the hearing apparatus 101 may register the electronic appliances using identification (ID) information of electronic appliances disposed inside the house of the user of the hearing apparatus 101. In another example, the hearing apparatus 101 may register the electronic appliances inside an office of the user or other locations where the user spends an extensive amount of time. The ID information refers to information that may be used for identifying the electronic appliances. For example, the ID information may include a product name, a serial number assigned during manufacturing, and ID of the electronic appliances.

When a pre-registered electronic appliance operates, the hearing apparatus 101 may pair with electronic appliances that are confirmed to be operating, without authenticating the electronic appliances that are pre-registered for communication or tuning frequencies to connect with the appliances.

For example, referring to FIG. 1, while an electronic appliance-1 102 is operating, the hearing apparatus 101 may pair 103 with the electronic appliance-1 102. When a plurality of electronic appliances that is registered with the hearing apparatus 101 is in operation, the hearing apparatus 101 may pair with the plurality of electronic appliances.

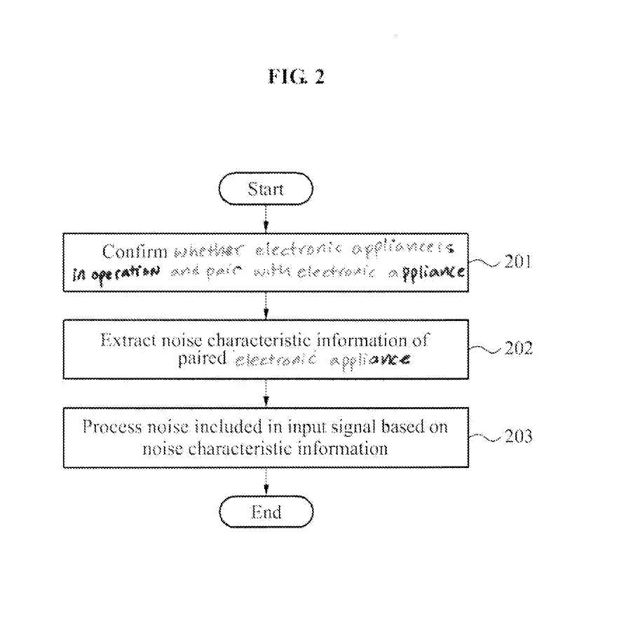

With reference to FIG. 2, an example of a method of processing noise of an electronic appliance registered with a hearing apparatus will be described. The method may process an input signal which includes the noise from an electronic appliance.

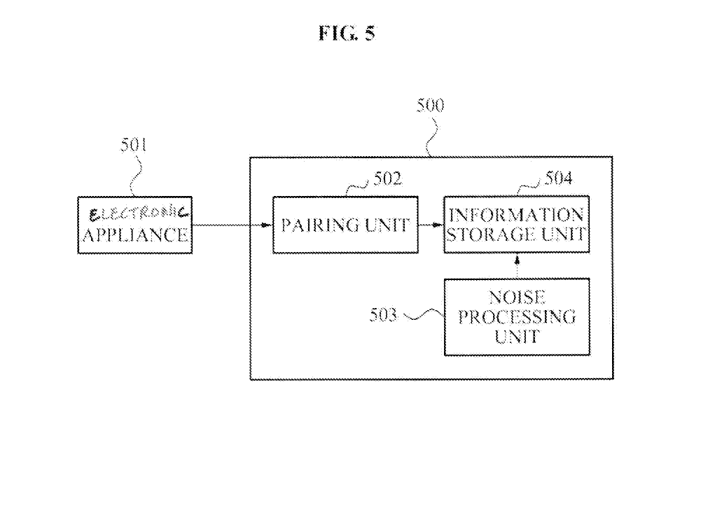

The method of processing noise illustrated in the flow chart of FIG. 2 may be performed by a hearing apparatus that is described with reference to FIG. 5.

Referring to FIG. 2, in operation 201, a hearing apparatus may first confirm whether the electronic appliance is operating and pair with the electronic appliance during its operation.

For example, the electronic appliance may be a home appliance. Home appliances such as a washing machine, a cleaner, a range hood, and the like may be disposed around the hearing apparatus inside a house. When an electronic appliance pre-registered with the hearing apparatus operates, the hearing apparatus may confirm the operation of the electronic appliance by receiving ID information of the electronic appliance from the electronic appliance. The ID information may be information used for distinguishing between electronic appliances, and may include information such as a product name, a serial number, an ID assigned during manufacturing of the electronic appliances, and the like.

In one example, the hearing apparatus may pair with only the electronic appliances that are confirmed to be operating. As aforementioned, the pre-registered electronic appliance may be directly connected with the hearing apparatus for communication without tuning of frequency with the electronic appliance or authentication.

When the electronic appliance is not operating, the hearing apparatus may output the noise corresponding to the electronic appliance without processing the noise from the input signal. That is, when the electronic appliance is not operating, the hearing apparatus may function as a general hearing aid that processes and transmits the input signal to be audible to a user.

Next, in operation 202, the hearing apparatus may extract noise characteristic information of the paired electronic appliance using the ID information of the paired electronic appliance.

For example, the noise characteristic information may be stored in the hearing apparatus during registration of the electronic appliance with the hearing apparatus. The hearing apparatus may store the noise characteristic information by matching the noise characteristic information with the ID information of the electronic appliance. Therefore, the hearing apparatus may extract noise characteristic information corresponding to the ID information of the paired electronic appliance, from the stored noise characteristic information of the electronic appliance.

The noise characteristic information of the electronic appliance may include at least one of time characteristic information and frequency characteristic information of a noise generated during operation of the electronic appliance. The time characteristic information may include information obtained using time as an axis, including time of a phase or an out-of-phase of the noise with reference to the noise generated during operation of the electronic appliance. The frequency characteristic information may include information obtained using frequency as an axis, including frequency of the noise generated during operation of the electronic appliance.

In operation 203, the hearing apparatus may process the noise of the electronic appliance, included in the input signal, based on the noise characteristic information of the paired electronic appliance. The input signal may be input through a microphone of the hearing apparatus. For example, the input signal may include a voice signal, a noise signal generated during the operation of the electronic appliance, and other signals generated by objects such as furniture, kitchen tools, and the like disposed around the hearing apparatus.

The hearing apparatus may process the noise of the electronic appliance included in the input signal, using the time characteristic information of the electronic appliance included in the noise characteristic information. For example, the hearing apparatus may reduce or eliminate the noise of the electronic appliance embedded in an input signal by adding a multiple of the out-of-phase wave of the noise generated from the electronic appliance to the input signal.

As another example, the hearing apparatus may process the noise included in the input signal using the frequency characteristic information of the electronic appliance, which is included in the noise characteristic information. For example, the hearing apparatus may reduce or remove the noise by subtracting the noise of frequency corresponding to the electronic appliance from the input signal.

As yet another example, when the plurality of electronic appliances are paired with the hearing apparatus, the hearing apparatus may parallel process the noise of the electronic appliances, the noise included in the input signal, based on the noise characteristic information of the paired electronic appliances. For example, when the user wearing the hearing apparatus enters an indoor space from an outdoor space, the hearing apparatus may pair with the plurality of electronic appliances simultaneously. Accordingly, the hearing apparatus may reduce or remove the noise of the paired electronic appliances from the input signal, using the time characteristic information or the frequency characteristic information of the noise of the paired electronic appliances. Here, the hearing apparatus may process the noise of the paired electronic appliances in the input signal simultaneously through the parallel processing.

As still another example, when the plurality of electronic appliances are paired with the hearing apparatus, the hearing apparatus may process the noise of the paired electronic appliances in the input signal, based on priority of the paired electronic appliances.

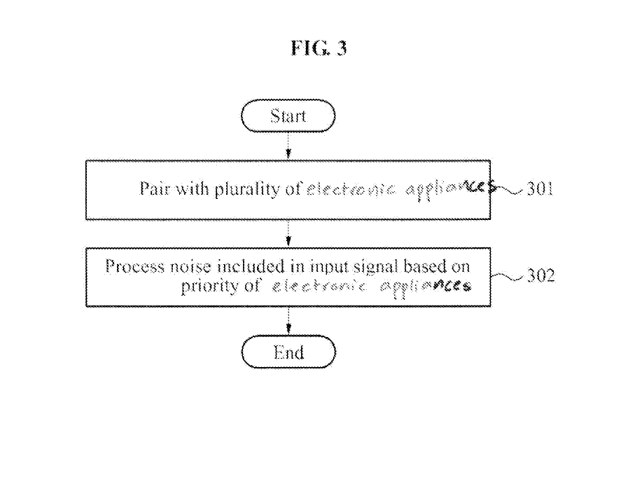

Hereinafter, an example of an operation of a hearing apparatus in processing noise from electronic appliances that are paired is described with reference to FIG. 3.

FIG. 3 includes a flow chart that illustrates an example of a method of processing noise based on priority of electronic appliances.

Referring to FIG. 3, in operation 301, a hearing apparatus is paired with a plurality of electronic appliances. After the pairing, in operation 202, the hearing apparatus may process noise of the electronic appliances included in an input signal based on the priority of the paired electronic appliances.

For example, the noise of the paired electronic appliances may be processed based on noise levels of the paired electronic appliances. That is, the hearing apparatus may process the noise of the electronic appliances in a descending order of the noise levels of the paired electronic appliances.

As another example, the hearing apparatus may process the noise of the paired electronic appliances based on distances to the paired electronic appliances. That is, the hearing apparatus may process the noise in an ascending order of distances between the hearing apparatus and the paired electronic appliances.

As yet another example, the hearing apparatus may process noise of the paired electronic appliances, based on both the noise levels of the paired electronic appliances and the distances between the hearing apparatus and the paired electronic appliances. That is, the hearing apparatus may process the noise in an ascending order of the distances and a descending order of the noise levels.

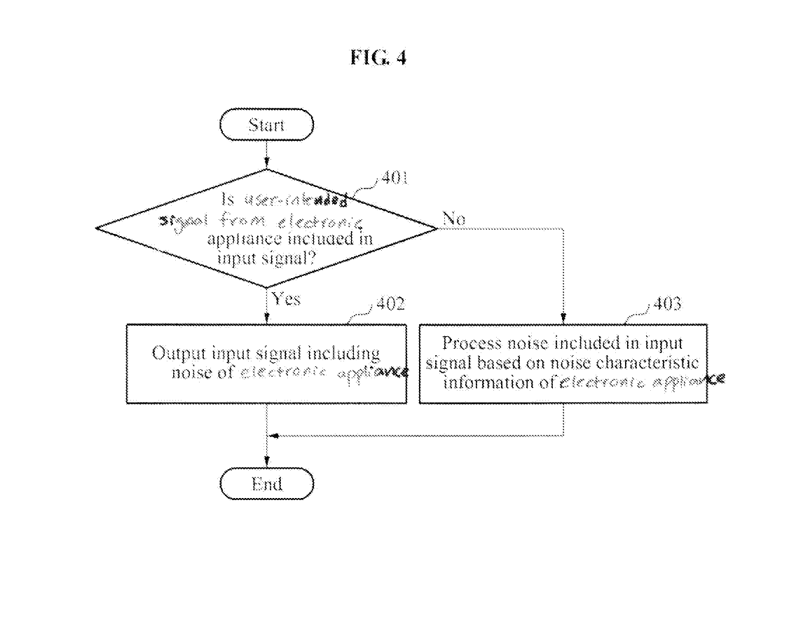

The flow chart in FIG. 4 illustrates an example of a method of processing noise based on the operation of paired electronic appliances. Some noise generated by the electronic appliances is intended to inform the user of the operation of the electronic appliance. These user-intended signals often differ from the background noise generated by the electronic appliances with respect to the time of occurrence of their generation, the frequency, the phase and/or amplitude of the sound.

Referring to FIG. 4, in operation 401, a processing unit of the hearing apparatus may make a determination as to whether a user-intended signal of an electronic appliance is included in the input signal. In the event that a user-intended signal, such as an operation completion signal, is included in the input signal (401: YES), in operation 402, the hearing apparatus may output the input signal that includes noise of the electronic appliance. That is, the hearing apparatus may distinguish between a user-intended signal and a background noise generated by an electronic appliance, and may be configured to remove the background noise without removing the user-intended signal from the input signal.

For example, when a washing machine is paired with a hearing apparatus, the washing machine may produce an operation completion alarm such as a loud high-pitch high-frequency beeping noise. The signal input to the hearing apparatus may include the operation completion signal indicating that the washing machine completed an operation. The processing unit of the hearing apparatus may determine the high-pitch noise as a user-intended signal, and the hearing apparatus may output the operation completion signal included in the input signal rather than removing or reducing the operation completion signal as the noise of the electronic appliance. Accordingly, the user may recognize the completion of the operation of the washing machine.

In the event that the processing unit of the hearing apparatus determines that the operation completion signal is not included in the input signal (401: NO), in operation 403, the hearing apparatus may process the noise of the electronic appliance included in the input signal based on noise characteristic information of the electronic appliance.

In this example, at least one of time characteristic information and frequency characteristic information may be used by the hearing apparatus to process the noise of the electronic appliance.

To differentiate between the background noise generated by the electronic appliance and the user-intended signals produced by the electronic appliance, the hearing apparatus may use information regarding the time of occurrence of the user-intended signals, the frequency, the phase and/or amplitude of the user-intended signal in comparison to the background noise generated by the electronic appliance. For example, each time a washing machine is in operation, it may produce a background noise characteristic to the washing machine. However, only about once in a while, the washing machine may produce a high pitch sound that differs from the background noise. The high pitch sound may be interpreted as a user-intended signal based on the time of occurrence, the frequency of the sound, the amplitude of the sound, and the like.

When the hearing apparatus is paired with a plurality of electronic appliances, the hearing apparatus may parallel process noise of the electronic appliances included in the input signal.

Furthermore, when paired with the plurality of electronic appliances, the hearing apparatus may determine priority of the electronic appliances and process the noise of the electronic appliances included in the input signal according to the priority. Here, the hearing apparatus may determine the priority based on at least one of noise levels of the paired electronic appliances and distances between the hearing apparatus and the electronic appliances.

FIG. 5 illustrates an example of a hearing apparatus 500.

According to FIG. 5, the hearing apparatus 500 may include a pairing unit 502, an information storage unit 503, and a noise processing unit 504.

An electronic appliance 501 that is located inside a house of a user of the hearing apparatus 500 may be pre-registered with the hearing apparatus 500 by using ID information. The ID information may be information used for identifying each electronic appliance. For example, the ID information may include a product name, a serial number assigned during manufacturing, and/or ID of the electronic appliance.

When a pre-registered electronic appliance 501 is in operation, the pairing unit 502 of the hearing apparatus 500 may pair the hearing apparatus 500 with the electronic appliance 501.

The information storage unit 503 may store ID information of one or more electronic appliances registered with the hearing apparatus 500. For example, during the registration of the electronic appliance with the hearing apparatus 500, the information storage unit 503 may store noise characteristic information by matching the noise characteristic information with the ID information of the electronic appliance.

Therefore, the noise processing unit 504 may extract noise characteristic information of the paired electronic appliance from the information storage unit 503 using the ID information of the paired electronic appliance. In this example, the noise characteristic information may include at least one of time characteristic information and frequency characteristic information of the noise generated during the operation of the electronic appliance.

The noise processing unit 504 may process the noise of the electronic appliance included in the input signal using the extracted noise characteristic information. That is, the noise processing unit 504 may process the noise of the paired electronic appliance in the input signal, using the time characteristic information or the frequency characteristic information of the noise generated during the operation of the paired electronic appliance 501.

For example, when the time characteristic information is used, the noise processing unit 504 may reduce or eliminate the noise of the electronic appliance using a phase or an out-of-phase information of the noise generated from the electronic appliance 501.

As another example, when the frequency characteristic information is used, the noise processing unit 504 may reduce or remove the noise of the electronic appliance 501 included in the input signal, by subtracting the noise having the frequency generated by the electronic appliance 501 from the input signal.

As yet another example, when the plurality of electronic appliances are paired simultaneously, the noise processing unit 504 may extract noise characteristic information corresponding to the ID information of the paired electronic appliances from the information storage unit 503.

In addition, the noise processing unit 504 may parallel process the noise of the electronic appliances included in the input signal based on the extracted noise characteristic information of the electronic appliances. For example, the noise processing unit 504 may reduce or remove the noise of the electronic appliances simultaneously using the extracted noise characteristic information.

In another example, when the plurality of electronic appliances are paired, the noise processing unit 504 may process the noise of the paired electronic appliances in the input signal, based on priority of the paired electronic appliances. For example, the noise processing unit 504 may process the noise included in the input signal based on at least one of noise levels of the paired electronic appliances and distances to the paired electronic appliances.

In one example, the noise processing unit 504 may process the noise in a descending order of the noise levels of the paired electronic appliances. Also, the noise processing unit 504 may process the noise in an ascending order of the distances between the hearing apparatus 500 and the electronic appliances. Furthermore, the noise processing unit 504 may process the noise using both the noise levels of the paired electronic appliances and the distances to the paired electronic appliances.

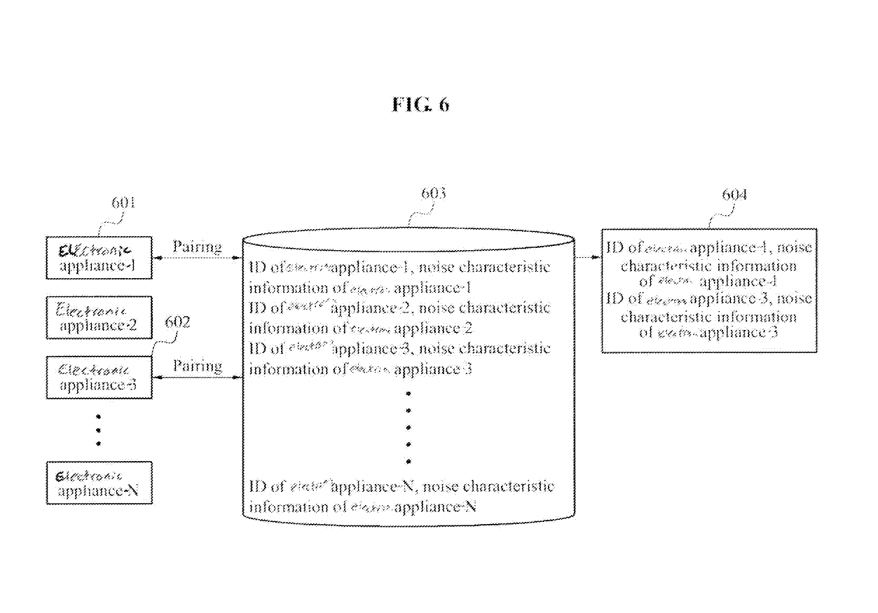

FIG. 6 illustrates an example of a method of extracting noise characteristic information of an electronic appliance that may be performed by a hearing apparatus.

In one example, the method of extracting the noise characteristic information of the electronic appliance from an information storage unit may be performed by a noise processing unit 504 among the various components constituting the hearing apparatus of FIG. 5.

Referring to FIG. 6, when an N-number of electronic appliances are registered with the hearing apparatus, the information storage unit may store noise characteristic information of the registered N-number of electronic appliances. Here, the information storage unit may store the noise characteristic information by matching ID information of the registered electronic appliances with the noise characteristic information.

When an electronic appliance-1 601 and an electronic appliance-3 602 are paired with a hearing apparatus among the N-number of registered electronic appliances, the noise processing unit of the hearing apparatus may extract noise characteristic information 604 of the electronic appliance-1 601 and the electronic appliance-3 602 from noise characteristic information 603 of the N-number of electronic appliances stored in the information storage unit. Accordingly, the noise processing unit may reduce or remove the noise of the electronic appliance-1 601 and the electronic appliance-3 602 included in the input signal, using the noise characteristic information 604 of the electronic appliance-1 601 and the electronic appliance-3 602.

As described with reference to FIG. 6, the hearing apparatus may process the noise of the electronic appliances without estimating the noise of the electronic appliances, by using the noise characteristic information of the electronic appliances, which is stored in advance during registration of the electronic appliances. Therefore, since an operation time for noise estimation is not required, the hearing apparatus may provide the user with a noise processed signal in real time. Moreover, the hearing apparatus may reduce power consumption required for noise estimation.

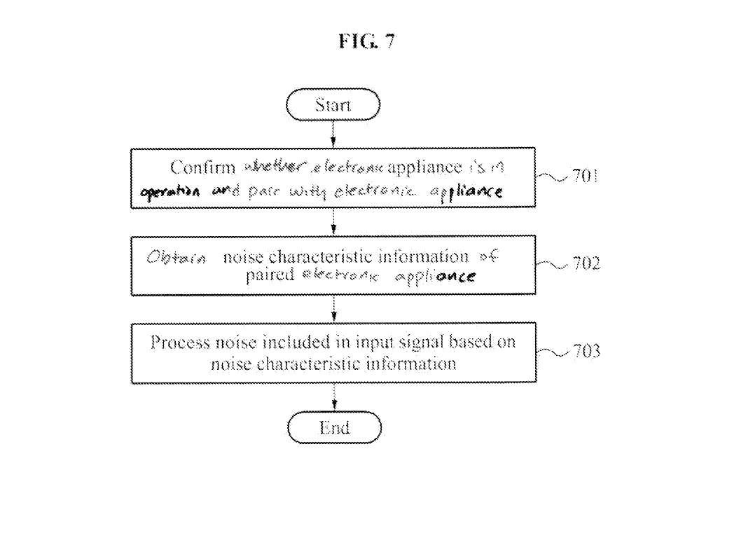

FIG. 7 illustrates another example of a noise processing method.

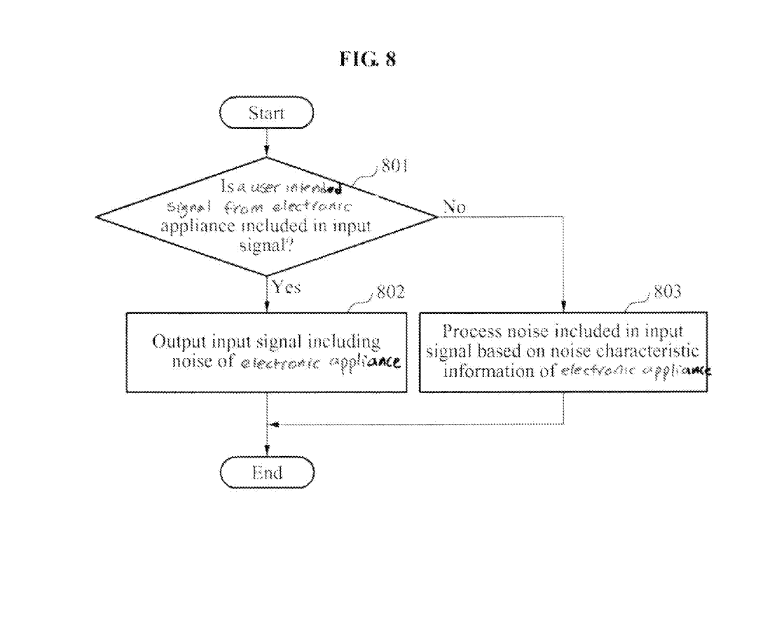

The noise processing method of FIG. 7 may be performed by a hearing apparatus shown in FIG. 8.

Referring to FIG. 7, in operation 701, the hearing apparatus may confirm operation of an electronic appliance located within a predetermined distance from the hearing apparatus and pair with the electronic appliance that is confirmed to be in operation.

Next, in operation 702, the hearing apparatus may receive noise characteristic information of the paired electronic appliance from the paired electronic appliance.

The noise characteristic information may include at least one of time characteristic information and frequency characteristic information of the electronic appliance. For example, the time characteristic information may include a phase or an out-of-phase of the noise with reference to the noise generated during operation of the electronic appliance along a time axis. The frequency characteristic information may include frequency of the noise with reference to the noise generated during operation of the electronic appliance along a frequency axis.

In operation 703, the hearing apparatus may process the noise of the electronic appliance that is included in the input signal based on the noise characteristic information received from the paired electronic appliance.

For example, when using the time characteristic information, the hearing apparatus may reduce or remove the noise of the electronic appliance by adding a multiple of an out-of-phase wave of the noise that is characteristically generated from the electronic appliance.

When using the frequency characteristic information, the hearing apparatus may reduce or eliminate the noise by subtracting from the input signal the noise having the frequency of the noise characteristically generated by the electronic appliance.

In another example, when the plurality of electronic appliances are paired with the hearing apparatus, the hearing apparatus may parallel process the noise of the electronic appliances that is included in the input signal, based on the noise characteristic information of the paired electronic appliances. The hearing apparatus may process the noise of the paired electronic appliances in the input signal simultaneously.

In another example, when the plurality of electronic appliances are paired with the hearing apparatus, the hearing apparatus may process the noise of the paired electronic appliances in the input signal, based on priority of the paired electronic appliances. For example, the hearing apparatus may determine the priority based on at least one of noise levels of the paired electronic appliances and distances between the hearing apparatus and the electronic appliances.

For example, the hearing apparatus may assign higher priority to an electronic appliance having a higher noise level among the paired electronic appliances. Also, the hearing apparatus may assign higher priority to an electronic appliance disposed at a shorter distance to the hearing apparatus. In addition, the hearing apparatus may assign higher priority to electronic appliance disposed at a shorter distance to the hearing apparatus and having a higher noise level. The hearing apparatus may process the noise of the electronic appliances in order of higher priority.

FIG. 8 illustrates another example of a method of processing noise based on the operation of electronic appliances.

Referring to FIG. 8, the hearing apparatus makes a determination as to whether a user-intended signal, such as an operation completion signal, of an electronic appliance is included in the input signal (801: YES) in operation 801. In the event that a user-intended signal is included in the input signal, the hearing apparatus may output the input signal including noise of the electronic appliance in operation 802.

For example, when a paired electronic appliance produces an operation completion alarm, the signal input to the hearing apparatus may include the operation completion signal. As the operation completion alarm may provide useful information to the user, the hearing apparatus may output the operation completion signal included in the input signal rather than remove or eliminate the operation completion signal as a noise coming from the electronic appliance. Accordingly, the user may recognize the completion of the operation of the electronic appliance, such as a washing machine.

In the event that the hearing apparatus determines that the operation completion signal is not included in the input signal (801: NO) in operation 801, the hearing apparatus may reduce or eliminate the noise of the electronic appliance included in the input signal based on noise characteristic information of the electronic appliance. The noise characteristic information may include at least one of time characteristic information and frequency characteristic information.

When a plurality of electronic appliances are paired with the hearing apparatus, the hearing apparatus may parallel process the noise of the electronic appliances included in the input signal using noise characteristic information received from the electronic appliances.

When the plurality of electronic appliances are paired with the hearing apparatus, the hearing apparatus may determine priority of the electronic appliances. The hearing apparatus may process the noise of the paired electronic appliances using the noise characteristic information according to the priority using the noise characteristic information received from the electronic appliances. Here, the hearing apparatus may determine the priority based on at least one of the noise levels of the paired electronic appliances and distances between the hearing apparatus and the electronic appliances.

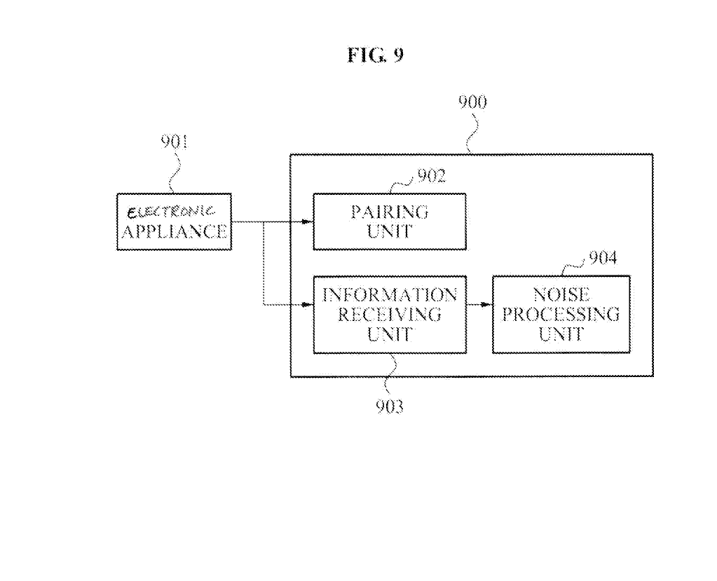

FIG. 9 illustrates another example of a hearing apparatus 900.

According to FIG. 9, the hearing apparatus 900 includes a pairing unit 902, an information receiving unit 903, and a noise processing unit 904.

When an electronic appliance 901 located around the hearing apparatus 900 is in operation, the pairing unit 902 may pair with the electronic appliance 901.

Therefore, the information receiving unit 903 may receive noise characteristic information of the paired electronic appliance 901 from the paired electronic appliance 901. The noise characteristic information may include at least one of time characteristic information and frequency characteristic information of noise generated during operation of the electronic appliance 901.

In addition, the noise processing unit 904 may process the noise of the electronic appliance 901, included in the input signal, using the noise characteristic information received from the electronic appliance 901.

For example, when the time characteristic information is used, the noise processing unit 904 may reduce or remove the noise of the electronic appliance 901 included in the input signal, using a phase or an out-of-phase wave of the noise generated during operation of the electronic appliance 901.

As another example, when the frequency characteristic information is used, the noise processing unit 904 may reduce or remove the noise of the electronic appliance 901 included in the input signal, by subtracting frequency of the noise generated during the operation of the electronic appliance 901 from the input signal.

As yet another example, when the plurality of electronic appliances are paired simultaneously, the information receiving unit 903 may receive noise characteristic information of the paired electronic appliances from the paired electronic appliances. Therefore, the noise processing unit 904 may parallel process the noise of the electronic appliances included in the input signal using the noise characteristic information of the electronic appliances.

As still another example, when the plurality of electronic appliances are paired, the noise processing unit 904 may process the noise of the paired electronic appliances in the input signal based on the priority of the paired electronic appliances.

The noise processing unit 904 may process the noise based on at least one of noise levels of the paired electronic appliances and distances to the electronic appliances.

For example, the noise processing unit 904 may process the noise in a descending order of the noise levels of the paired electronic appliances. Also, the noise processing unit 904 may process the noise in an ascending order of the distances between the hearing apparatus and the electronic appliances among the noise of the electronic appliances included in the input signal. Furthermore, the noise processing unit 904 may process the noise using both the noise levels of the paired electronic appliances and the distances to the paired electronic appliances.

The noise levels and the distances may be stored in advance in the hearing apparatus during registration of the hearing apparatus. When the plurality of electronic appliances are paired with the hearing apparatus 900, the information receiving unit 903 may receive the noise levels from the paired electronic appliances and the distances between the hearing apparatus and the paired electronic appliances.

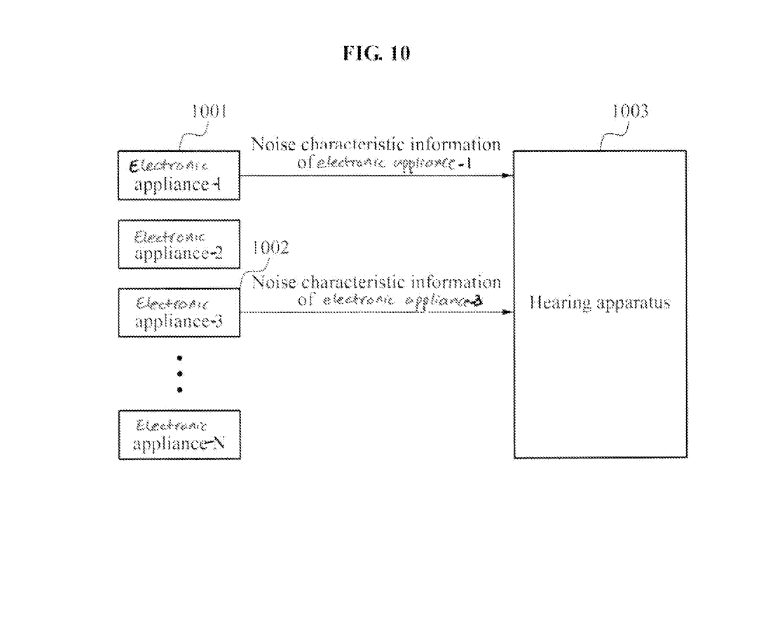

FIG. 10 illustrates a method of processing noise by receiving noise characteristic information of electronic appliances by another example of a hearing apparatus 1003.

The method of processing the noise using noise characteristic information of an electronic appliance received from the electronic appliance 1003 may be performed by a noise processing unit of the hearing apparatus illustrated in FIG. 9.

Referring to FIG. 10, when an electronic appliance-1 1001 and an electronic appliance-3 1002 are paired with the hearing apparatus 1003 among an N-number of electronic appliances registered with the hearing apparatus 1003, the hearing apparatus 1003 may receive noise characteristic information of the electronic appliance-1 1001 from the electronic appliance-1 1001. In addition, the hearing apparatus 1003 may receive noise characteristic information of the electronic appliance-3 1002 from the electronic appliance-3 1002. That is, the hearing apparatus 1003 may receive noise characteristic information from each electronic appliance.

Next, the hearing apparatus 1003 may process the noise from the electronic appliance-1 1001 and the noise from the electronic appliance-3 1002 that are included in an input signal, using the noise characteristic information of the electronic appliance-1 1001 and the electronic appliance-3 1002.

The hearing apparatus 1003 may process the noise of the electronic appliance-1 1001 and the electronic appliance-3 1002 simultaneously through parallel processing. In addition, the hearing apparatus 1003 may determine priority of the electronic appliance-1 1001 and the electronic appliance-3 1002 and process the noise of the electronic appliance-1 1001 and the electronic appliance-3 1002, included in the input signal, according to the priority. For example, the hearing apparatus 1003 may determine the priority of the electronic applicances based on at least one of noise levels of the electronic appliance-1 1001 and the electronic appliance-3 1002 and distances between the hearing apparatus 1003 and the electronic appliance-1 1001 and the electronic applicance-3 1002.

As described with reference to FIG. 10, the hearing apparatus may process the noise included in the input signal by using the noise characteristic information of the electronic appliances, rather than trying to estimate the noise of the electronic appliances as background noises. Therefore, the hearing apparatus may provide the user with a noise processed signal in real time while maintaining low power consumption for noise estimation.

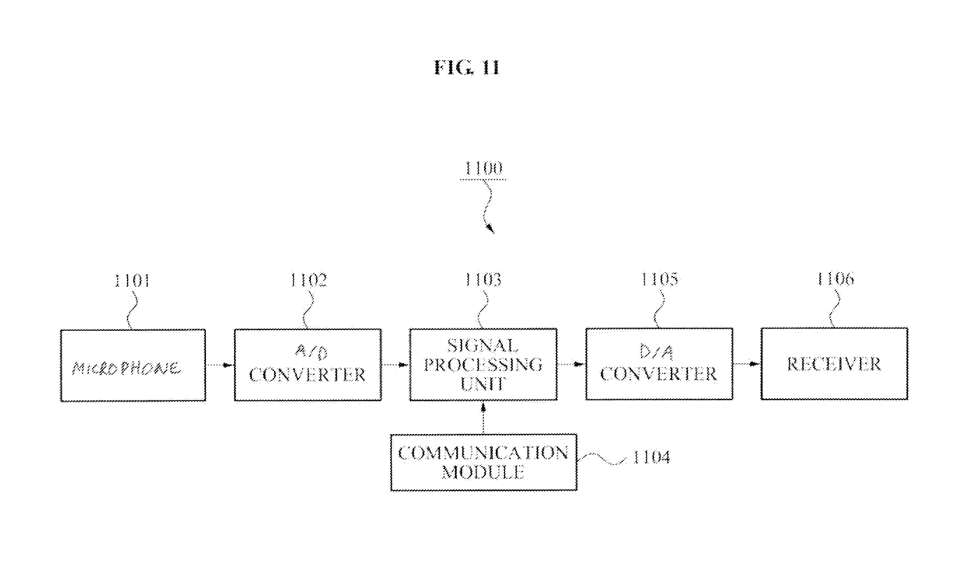

FIG. 11 is a diagram illustrating an example of a hearing apparatus 1100. The hearing apparatus 1100 implemented in the form of a hearing aid wearable by the user. The operation of pairing with an electronic appliance and processing noise of the electronic appliance described with reference to FIGS. 5 and 9 may be performed by a signal processing unit 1103 of FIG. 11.

According to FIG. 11, the hearing apparatus 1100 includes a microphone 1101, an analog-to-digital (A/D) converter 1102, the signal processing unit 1103, a communication module 1104, a digital to analog (D/A) converter 1105, and a receiver 1106.

First, the microphone 1101 may receive an input signal in an analog form in which voice signals of people around, noise signals generated by operation of electronic appliances disposed around, and other signals generated by objects such as furniture, kitchen tools, and the like are mixed.

The A/D converter 1102 may convert the input signal input through the microphone 1101 into a digital signal.

The signal processing unit 1103 may reduce or remove noise of the electronic appliance, included in the input signal converted into the digital form.

For example, when it is determined that an electronic appliance pre-registered with the hearing apparatus 1100 is in operation, the signal processing unit 1103 may pair with the electronic appliance. Using noise characteristic information of the electronic appliance, the signal processing unit 1103 may reduce or remove the noise of the electronic appliance included in the input signal. In this example, the noise characteristic information may include time characteristic information or frequency characteristic information of the noise.

In one example, the noise characteristic information of the electronic appliance may be stored in advance during registration of the electronic appliance with the hearing apparatus 1100. The noise characteristic information may be matched with ID information of the electronic appliance and stored. Accordingly, the signal processing unit 1103 may extract noise characteristic information of the paired electronic appliance among the pre-stored noise characteristic information of the electronic appliance, using the ID information of the electronic appliance received through the communication module 1104. In addition, the signal processing unit 1103 may reduce or remove the noise of the electronic appliance included in the input signal, based on the extracted noise characteristic information.

When a plurality of electronic appliances are paired, the signal processing unit 1103 may process the noise of the electronic appliances included in the input signal, based on the noise characteristic information of the plurality of electronic appliances. Further, the signal processing unit 1103 may determine priority of the paired electronic appliances and process the noise of the electronic appliances according to the priority.

When a user-intended signal, such as an operation completion signal, of the paired electronic appliance is included in the input signal, the signal processing unit 1103 may output the input signal including the noise of the electronic appliance. Thus, when the input signal is output with the noise unprocessed, the user may receive the user-intended signal from the electronic appliance. For example, the user may recognize the completion of the operation of the electronic appliance such as a washing machine through an alarm produced by the washing machine when the washing is complete.

As another example, when an electronic appliance disposed around the hearing apparatus 1100 is in operation, the signal processing unit 1103 may pair with the electronic appliance. In addition, the signal processing unit 1103 may receive the noise characteristic information of the electronic appliance from the paired electronic appliance through the communication module 1104. The communication module 1104 may include an infrared (IR) communication module, a radio frequency (RF) module, and a Bluetooth communication module.

Next, the signal processing unit 1103 may reduce or remove the noise of the electronic appliance included in the input signal using the received noise characteristic information. The noise characteristic information received from the electronic appliance may include at least one of time characteristic information and frequency characteristic information of the noise.

In this example, when the plurality of electronic appliances are paired, the signal processing unit 1103 may parallel process the noise of the electronic appliances included in the input signal based on the noise characteristic information of the plurality of electronic appliances. In addition, the signal processing unit 1103 may determine priority of the paired electronic appliances and process the noise of the electronic appliances according to the priority.

When an operation completion signal of the paired electronic appliance is included in the input signal, the signal processing unit 1103 may output the input signal including the noise of the electronic appliance. Accordingly, the user of the hearing apparatus 1100 may recognize completion of the operation of the electronic appliance.

The D/A converter 1105 may receive the signal of which the noise is processed from the signal processing unit 1103 and convert the digital signal into an analog signal. When a user-intended signal, such as an operation completion signal, of the electronic appliance is included, the D/A converter 1105 may convert the signal including the noise into an analog signal.

The receiver 1106 may transmit the analog signal converted by the D/A converter 1105 to the user. For example, the receiver 1106 may be a speaker.

As aforementioned with reference to FIG. 11, a hearing apparatus may be implemented in the form of a hearing aid wearable by a user and may process noise of an electronic appliance that is included in an input signal.

In addition, the hearing apparatus may be implemented in the form of a Bluetooth headset and a Bluetooth earphone.

A hearing apparatus described above may process noise of an electronic appliance that is included in an input signal such that the noise is reduced within a range by which a user may recognize that the electronic appliance is operating. That is, when the hearing apparatus is paired with an electronic appliance that generates loud operational noise, such as a washing machine, a range hood, a cleaner, and the like, the hearing apparatus may reduce the operational noise of the electronic appliance without completely eliminating the noise. Therefore, the user may feel less uncomfortable from the operational noise of the electronic appliance while still being capable of recognizing the operation state of the electronic appliance.

Described above are various examples of noise processing methods. In one example, the noise processing method involves pairing with a pre-registered electronic appliance when the pre-registered electronic appliance operates, extracting noise characteristic information of the paired electronic appliance using identification (ID) information of the paired electronic appliance, and processing noise of the electronic appliance included in an input signal based on the noise characteristic information.

The processing of the noise may include processing the noise included in the input signal using time characteristic information of the electronic appliance, the time characteristic information included in the noise characteristic information.

The processing of the noise may include processing the noise included in the input signal using frequency characteristic information of the electronic appliance, the frequency characteristic information included in the noise characteristic information.

The processing of the noise may include parallel processing noise of a plurality of electronic appliances, the noise included in the input signal, based on the noise characteristic information of the plurality of electronic appliances being paired when pairing with the plurality of electronic appliances is achieved.

The processing of the noise may include processing noise of a plurality of electronic appliances, the noise included in the input signal, based on priority of the plurality of electronic appliances being paired when pairing with the plurality of electronic appliances is achieved.

The processing of the noise may include processing noise of a plurality of electronic appliances, the noise included in the input signal, based on at least one of noise levels of the plurality of electronic appliances being paired and distances to the plurality of electronic appliances, when pairing with the plurality of electronic appliances is achieved.

The processing of the noise may include outputting the input signal including the noise of the electronic appliance when operation of the paired electronic appliance is completed.

In another example, a noise processing method includes pairing with an electronic appliance disposed around when the electronic appliance operates, receiving noise characteristic information of the electronic appliance from the electronic appliance being paired, and processing noise of the electronic appliance, the noise included in an input signal, based on the noise characteristic information.

The processing of the noise may include processing noise of the electronic appliance, the noise included in the input signal, using time characteristic information of the electronic appliance included in the noise characteristic information.

The processing of the noise may include processing noise of the electronic appliance, the noise included in the input signal, using frequency characteristic information of the electronic appliance included in the noise characteristic information.

The processing of the noise may include parallel processing noise of a plurality of electronic appliances, the noise included in the input signal, based on the noise characteristic information of the plurality of electronic appliances being paired when pairing with the plurality of electronic appliances is achieved.

The processing of the noise may include processing noise of a plurality of electronic appliances, the noise included in the input signal, based on priority of the plurality of electronic appliances being paired when pairing with the plurality of electronic appliances is achieved.

The processing of the noise may include processing noise of a plurality of electronic appliances, the noise included in the input signal, based on at least one of noise levels of the plurality of electronic appliances being paired and distances to the plurality of electronic appliances, when pairing with the plurality of electronic appliances is achieved.

The processing of the noise may include outputting the input signal including the noise of the electronic appliance when operation of the paired electronic appliance is completed.

In another example, a hearing apparatus includes a pairing unit to perform pairing with a pre-registered electronic appliance when the pre-registered electronic appliance operates, and a noise processing unit to extract noise characteristic information of the paired electronic appliance using identification (ID) information of the paired electronic appliance and to process noise of the electronic appliance included in an input signal based on the noise characteristic information.

The noise processing unit may process the noise of the electronic appliance included in the input signal using time characteristic information of the electronic appliance included in the noise characteristic information.

The noise processing unit may process the noise of the electronic appliance included in the input signal using frequency characteristic information of the electronic appliance included in the noise characteristic information.

In another example, a hearing apparatus includes a pairing unit to perform pairing with an electronic appliance disposed around when the electronic appliance operates, an information receiving unit to receive noise characteristic information of the electronic appliance from the paired electronic appliance, and a noise processing unit to process noise of the electronic appliance, the noise included in an input signal, based on the noise characteristic information.

The noise characteristic information may include at least one of time characteristic information of the electronic appliance and frequency characteristic information of the electronic appliance.

The various units, modules, apparatus, converters and receivers may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic to logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing noise, comprising:
pairing a hearing apparatus with an electronic appliance;
extracting noise characteristic information of the paired electronic appliance; and
processing noise from the electronic appliance included in an input signal based on the noise characteristic information.

2. The method of claim 1, wherein the noise characteristic information includes time characteristic information; and the processing of the noise comprises reducing or eliminating the noise from the electronic appliance that is included in the input signal using the time characteristic information.

3. The method of claim 1, wherein the noise characteristic information includes frequency characteristic information, and the processing of the noise comprises processing the noise from the electronic appliance that is included in the input signal using the frequency characteristic information.

4. The method of claim 1, wherein the processing of the noise comprises parallel processing noise from a plurality of electronic appliances based on the noise characteristic information of each of the plurality of electronic appliances that are paired.

5. The method of claim 1, wherein the processing of the noise comprises processing noise from a plurality of electronic appliances based on priority of the plurality of electronic appliances.

6. The method of claim 1, wherein the processing of the noise comprises processing noise from a plurality of electronic appliances based on noise levels of the plurality of electronic appliances that are paired, distances between the hearing apparatus and each of the plurality of electronic appliances that are paired, or a combination thereof.

7. The method of claim 1, wherein the processing of the noise comprises outputting the input signal including the noise from the electronic appliance when the input signal includes a user-intended signal from the paired electronic appliance.

8. A method of processing noise, comprising:
pairing with an electronic appliance;
obtaining noise characteristic information of the electronic appliance during the pairing; and
processing noise from the electronic appliance that is included in an input signal, based on the noise characteristic information.

9. The method of claim 8, wherein the processing of the noise comprises processing the noise from the electronic appliance using time characteristic information of the electronic appliance included in the noise characteristic information.

10. The method of claim 8, wherein the processing of the noise comprises processing the noise from the electronic appliance using frequency characteristic information of the electronic appliance included in the noise characteristic information.

11. The method of claim 8, wherein the processing of the noise comprises parallel processing noise from a plurality of electronic appliances based on the noise characteristic information of the plurality of electronic appliances that are paired.

12. The method of claim 8, wherein the processing of the noise comprises processing noise from a plurality of electronic appliances based on priority of the plurality of electronic appliances that are paired.

13. The method of claim 8, wherein the processing of the noise comprises processing noise from a plurality of electronic appliances based on noise levels of the plurality of electronic appliances that are paired, distances between the hearing apparatus and each of the plurality of electronic appliances that are paired, or a combination thereof.

14. The method of claim 8, wherein the processing of the noise comprises outputting the input signal that includes the noise from the electronic appliance in response to a determination that the input signal includes a user-intended signal from the electronic appliance.

15. A hearing apparatus comprising:
a pairing unit configured to pair with a pre-registered electronic appliance; and
a noise processing unit configured to extract noise characteristic information of the paired electronic appliance and to process noise from the electronic appliance that is included in an input signal based on the noise characteristic information.

16. The hearing apparatus of claim 15, wherein the noise processing unit is configured to process the noise from the electronic appliance included in the input signal using time characteristic information of the electronic appliance included in the noise characteristic information.

17. The hearing apparatus of claim 15, wherein the noise processing unit is configured to process the noise from the electronic appliance included in the input signal using frequency characteristic information of the electronic appliance included in the noise characteristic information.

18. A hearing apparatus comprising:
a pairing unit configured to pair with an electronic appliance that is in operation;
an information receiving unit configured to receive noise characteristic information of the electronic appliance from the paired electronic appliance; and
a noise processing unit configured to process noise from the electronic appliance that is included in an input signal, based on the noise characteristic information.

19. The hearing apparatus of claim 18, wherein the noise characteristic information comprises characteristic information of the electronic appliance, frequency characteristic information of the electronic appliance, or a combination thereof.

20. A non-transitory computer readable recording medium storing a program to cause a processing device to perform the method of claim 1.
